(19) United States
(12) Patent Application Publication
(10) Pub. No.: US 2018/0370652 A1
(43) Pub. Date: Dec. 27, 2018

(54) PORTABLE DRONE LANDING PLATFORM

(71) Applicants: Martin Pierre George Vendrame, Edmonton (CA); Natalia Bakumenko, Edmonton (CA)

(72) Inventors: Martin Pierre George Vendrame, Edmonton (CA); Natalia Bakumenko, Edmonton (CA)

(21) Appl. No.: 15/632,505

(22) Filed: Jun. 26, 2017

(51) Int. Cl. B64F 1/02; B64F 1/04; B64C 39/02

(52) U.S. Cl. CPC B64F 1/02; B64F 1/00; B64C 39/024; B64F 1/04

(57) ABSTRACT

The present invention provides a portable landing platform for a multi-rotor drone, comprising: a landing surface, the landing surface comprising two sections connected by a folding mechanism operative to permit the landing surface to fold into two parts; a plurality of legs, each leg secured to an underside of the landing surface such that the legs support the landing surface when unfolded; and a handle, the handle integrated into the landing surface and dimensioned to be held in a single hand by a user, wherein the portable landing platform can be folded and unfolded by a single user.

### FIELD OF THE INVENTION

The present specification relates generally to landing platforms for drones and, in particular, to a portable takeoff and landing platform for multi-rotor drones.

### BACKGROUND OF THE INVENTION

Drones (unmanned flying vehicles) of various sizes and design have become commonplace over recent years and usage and popularity is steadily increasing over time. Drones are used as a personal recreation pastime, for commercial applications (e.g. package delivery) and professional purposes (e.g. construction surveys, photography, videography).

One of the challenges when operating drones is in the takeoff and landing procedures. As the drones are relatively small and light, and often have minimal or no landing gear, it may be difficult to launch or land a drone when the terrain is rough or uneven. As many commercial drones are of a multi-rotor design (generally four, six or eight rotors), a stable and safe takeoff and landing platform is important for effective operation. Another difficultly arises in commercial use (e.g. construction site surveys) when dealing with soft or wet terrain (mud, snow, etc.) outdoors, especially if weather conditions change during operation.

It would be preferable to provide a flat takeoff/landing surface for drone operation. However, it may not always be possible or convenient for the user to modify the terrain to provide a workable surface, particularly for surfaces such as mud and snow. Thus, it would also be preferably to provide a portable takeoff/landing platform that is transportable by the user and may be placed on any terrain to provide a flat surface for multi-rotor drone operation.

Accordingly, there remains a need for improvements in the art.

### SUMMARY OF THE INVENTION

In accordance with an aspect of the invention, there is provided portable, foldable landing platform for multi-rotor drones.

According to an embodiment of the invention, there is provided a portable landing platform for a drone, comprising: a landing surface, the landing surface comprising two sections connected by a folding mechanism operative to permit the landing surface to fold into two parts; a plurality of legs, each leg secured to an underside of the landing surface such that the legs support the landing surface when unfolded; and a handle, the handle integrated into the landing surface and dimensioned to be held in a single hand by a user, wherein the portable landing platform can be folded and unfolded by a single user.

According to another embodiment of the invention, the folding mechanism comprises a single hinge running along a central axis of the landing surface, the single hinge connected to each section of the landing surface via a flange.

According to another embodiment of the invention, the folding mechanism comprises a pair of hinges each running parallel to a central axis of the landing surface and joined by a surface segment, each hinge connected to one of the sections of the landing surface.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a top perspective view of a landing platform according to an embodiment;

FIG. 2 is a bottom perspective view of the landing platform of FIG. 1;

FIG. 3 is a bottom perspective view of the landing platform of FIG. 2 with the legs removed;

FIG. 4 is a side view of the landing platform of FIG. 1 in a folded position;

FIG. 5 is a front view of the landing platform of FIG. 4;

FIG. 6A is a side elevation view of an adjustable leg in a folded position according to an embodiment;

FIG. 6B is a side elevation view of the adjustable leg of FIG. 6A in an unfolded position;

FIG. 7A is a top perspective view of a landing platform according to an embodiment;

FIG. 7B is a top perspective view of the landing platform of FIG. 7A in a folded position; and

FIGS. 8A-8F are top views of landing platforms according to various embodiments.

Like reference numerals indicated like or corresponding elements in the drawings.

### DETAILED DESCRIPTION OF THE EMBODIMENTS

The present invention is a landing platform for drones and, in particular, to a portable, foldable landing platform for multi-rotor drones (e.g. generally with four, six or eight rotors) that do not require a runway or equivalent for takeoff and/or landing. In the context of this specification, it is to be understood that a “landing platform” is a platform that may be used for both takeoff and landing procedures.

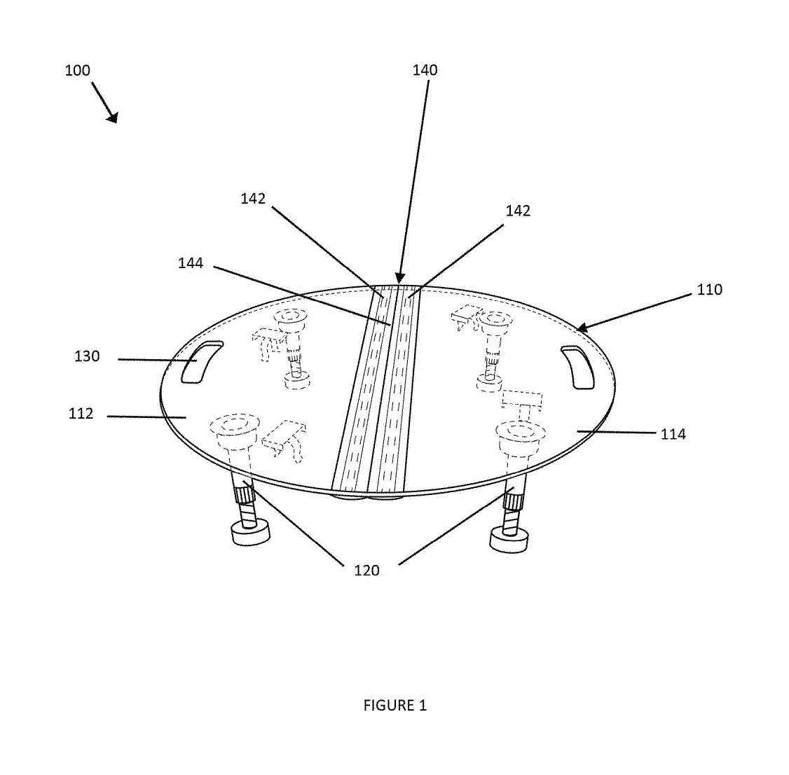

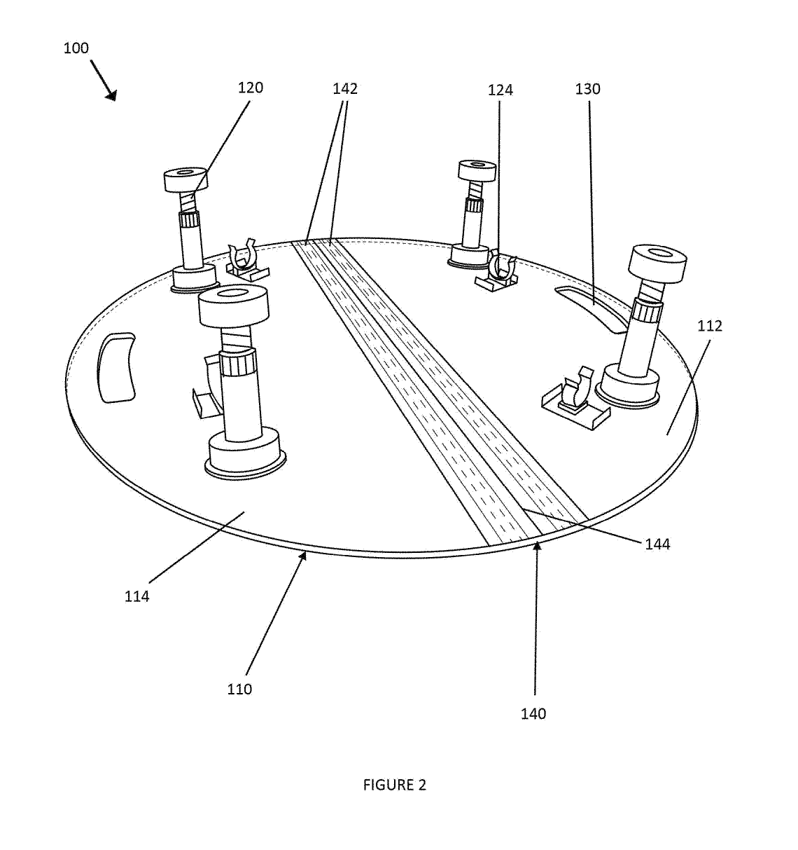

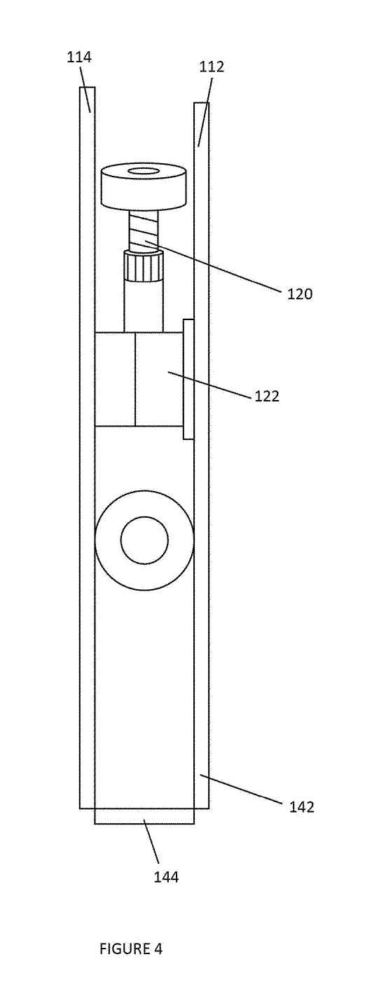

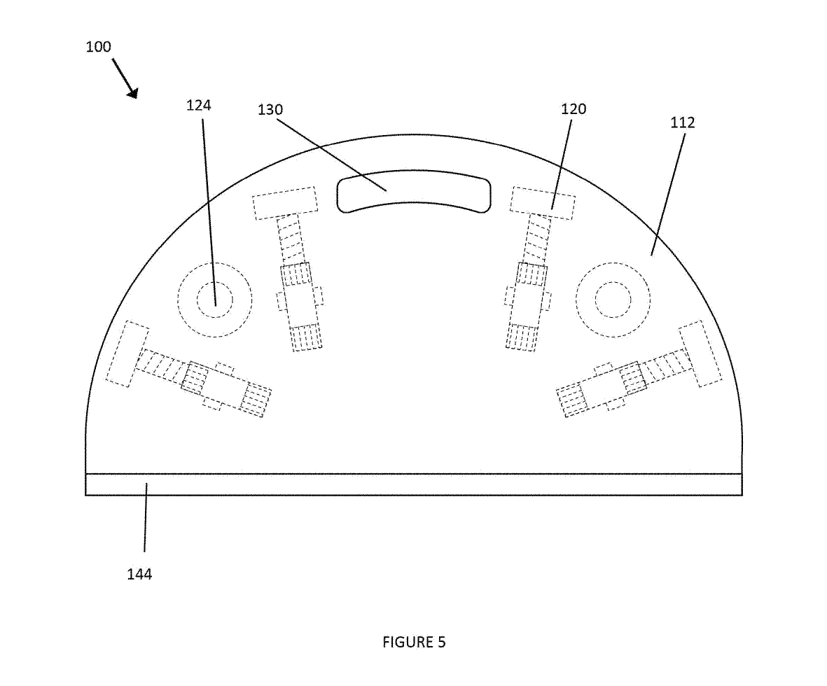

According to an embodiment as shown in FIGS. 1 and 2, portable landing platform 100 may include a landing surface 110 supported by one or more legs 120. The landing platform may further include handles 130 to assist in carrying and transportation. Folding mechanism 140 enables the landing surface 110 to be folded as shown in FIGS. 4 and 5, again to assist in carrying and transportation. As shown, landing surface 110 is circular, however other shapes (e.g. oval, square, rectangular, octagonal) may be used as desired.

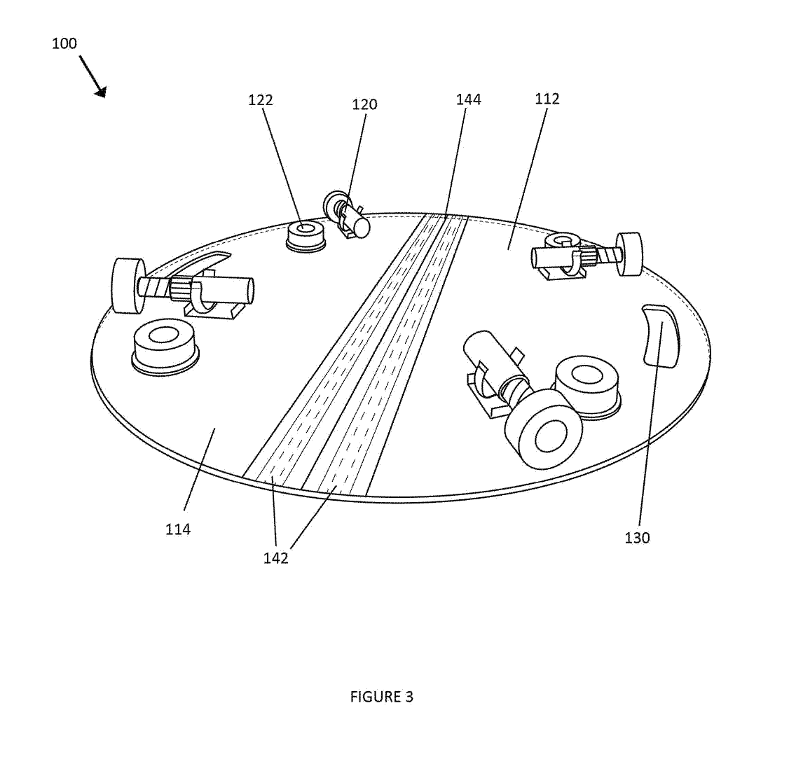

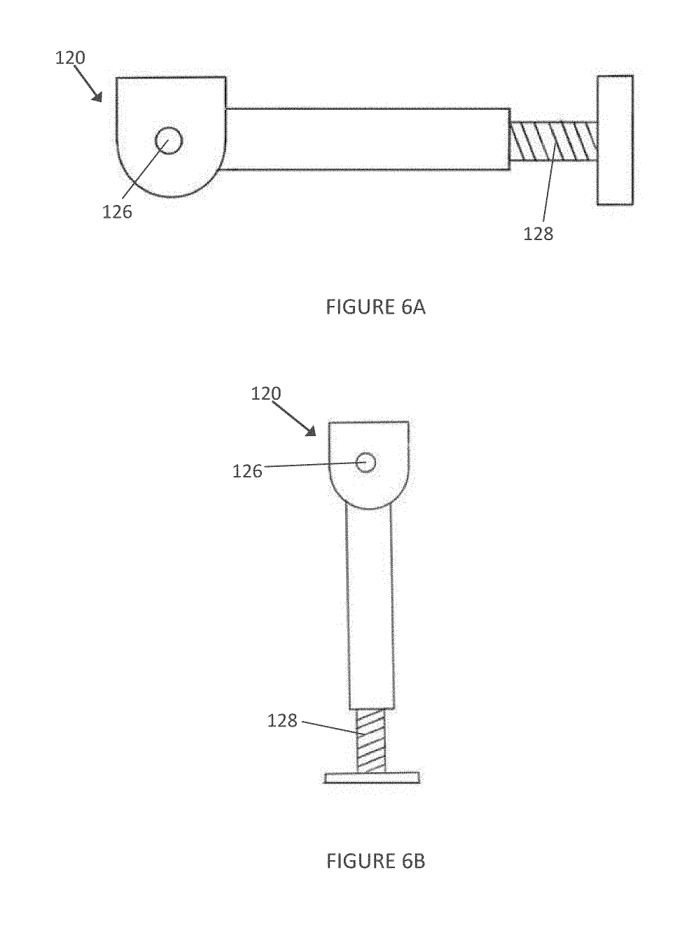

As shown in FIGS. 2 and 3, legs 120 may be removably secured to landing surface 110 by screw mounts 122. Clips 124 may be provided on the bottom of landing surface 110 to secure legs 120 in place when removed. Alternatively, as shown in FIGS. 6A and 6B, legs 120 may be secured to landing surface 110 by folding mounts 126, enabling legs 120 to be unfolded for use, and folded against landing surface 110 to permit landing surface 110 to be folded. Legs 120 may also be adjustable, by a screw thread 128 as shown in FIG. 6A, or by a telescoping mechanism, or similar means. By incorporating an adjustment mechanism into legs 120, each leg 120 may be individually adjusted in height to compensate for variations in the surface upon which landing platform 100 is placed, and ensuring that landing surface 110 is substantially flat.

As shown in FIGS. 1 and 2, folding mechanism 140 may consist of a pair of hinges 142, connected by surface segment 144, and each hinge connected to a section (112, 114) of landing surface 110. Each section 112, 114 may be folded down via hinge 142 to collapse landing platform 100 for transport. Surface segment 144 ensures that, when folded, there is a space provided between sections 112 and 114 for legs 120.

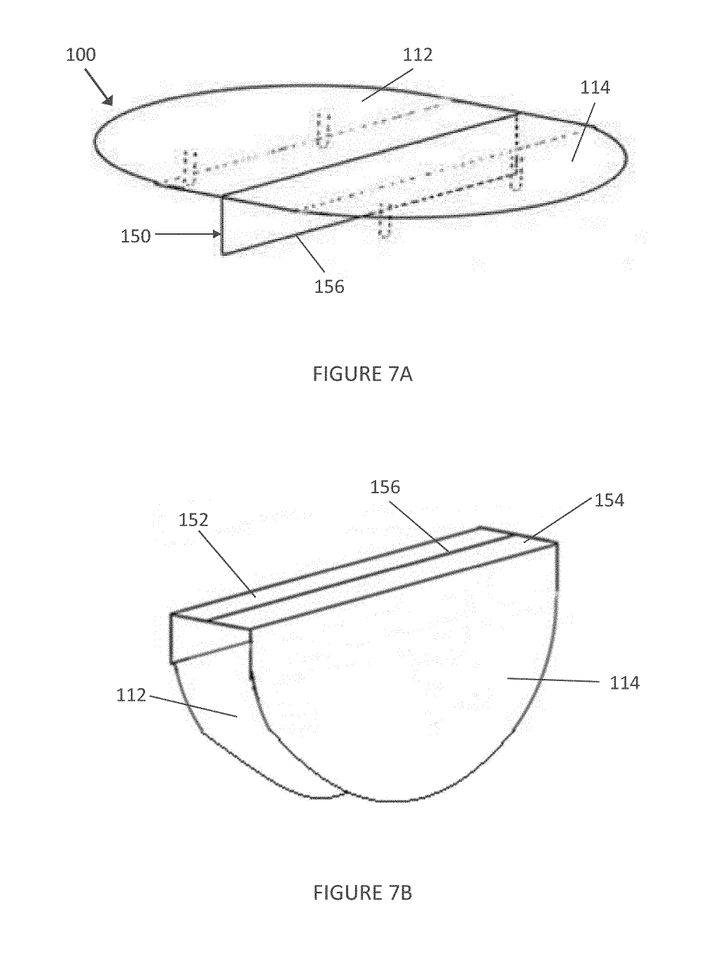

An alternative folding mechanism 150 is shown in FIGS. 7A and 7B. Each section 112, 114 may have a flange 152, 154, each flange 152, 154 being substantially perpendicular to the surface of each section 112, 114. Flanges 152, 154 are connected by hinge 156 to enable landing platform 100 to be folded for transport. Flanges 152, 154 provide space between sections 112, 114 when folded for legs 120 to be stored.

Depending on the size of surface segment 144 (or flanges 152, 154) it may also be possible to have legs 120 permanently secured to the bottom of landing surface 110, with the legs 120 extendible (by screw threads, telescoping, etc.) to a length greater than that of the surface segment 144 (or flanges 152, 154). In this case, it would then be necessary to retract the legs 120 to a length less than that of the surface segment 144 (or flanges 152, 154) to permit folding of landing surface 110.

As shown, sections 112 and 114 are substantially similar in size, and folding mechanism 140 (or 150) is oriented generally along an axis of symmetry of landing surface 110. However, sections 112 and 114 may be of different sizes, and folding mechanism 140 (or 150) may be located elsewhere on landing surface 110, depend on the shape and overall size of landing surface 110.

In operation, portable landing platform 100 may be transported in the folded position. When the desired location for drone operation is found, platform 100 may be unfolded via folding mechanism 140 (or 150) to provide landing surface 110, and legs 120 attached or unfolded as necessary to support landing surface 110. Legs 120 may further be individually height adjusted by screw threads, telescoping, or other means to ensure that landing surface 110 is substantially flat for drone takeoff and landing procedures. If the user desires to change locations, legs 120 may be detached or folded, and landing surface 110 folded via folding mechanism 140 (or 150) for transport. Handles 130 may be used by the user to carry the platform 100 once folded.

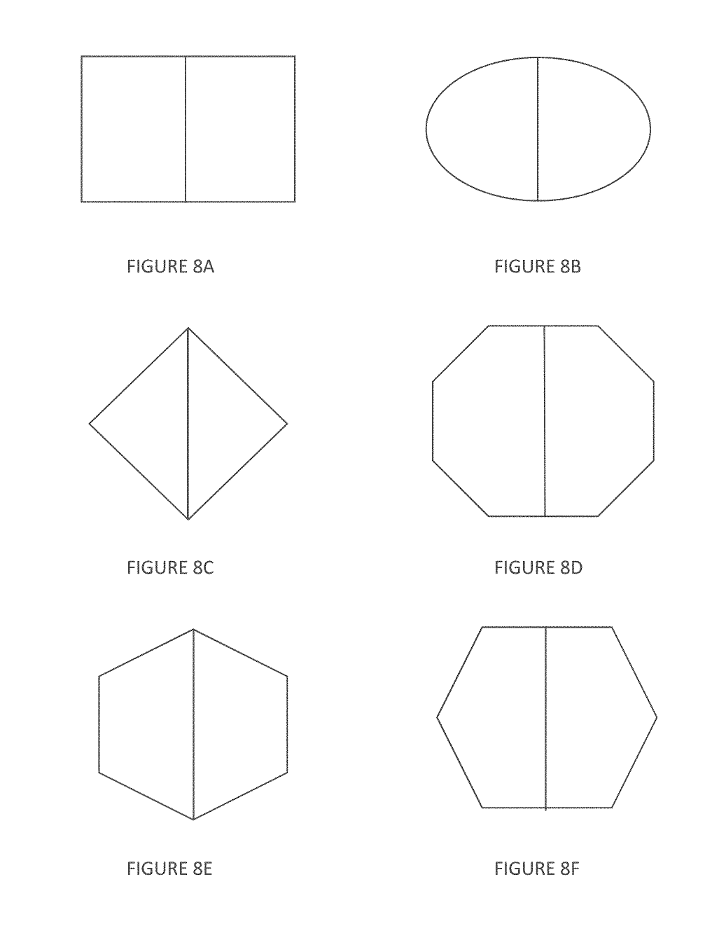

As shown, the number of legs 120 is four, and the legs 120 are disposed symmetrically, however, the number of legs and pattern of disposition may be varied according to the size and shape of landing surface 110. As shown in FIGS. 8A to 8F, the shape of the landing platform may be rectangular, oval, diamond, octagonal, or hexagonal. The folding mechanism 140 may be disposed through a vertice as in FIGS. 8C and 8E, or a face, as in FIGS. 8A, 8D and 8F.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A portable landing platform for a drone, comprising:
a landing surface, the landing surface comprising two sections connected by a folding mechanism operative to permit the landing surface to fold into two parts;
a plurality of legs, each leg secured to an underside of the landing surface such that the legs support the landing surface when unfolded; and
a handle, the handle integrated into the landing surface and dimensioned to be held in a single hand by a user,
wherein the portable landing platform can be folded and unfolded by a single user.

2. The platform of claim 1, wherein the folding mechanism comprises a single hinge running along a central axis of the landing surface, the single hinge connected to each section of the landing surface via a flange.

3. The platform of claim 1, wherein the folding mechanism comprises a pair of hinges each running parallel to a central axis of the landing surface and joined by a surface segment, each hinge connected to one of the sections of the landing surface.

4. The platform of claim 1, wherein the legs are foldable against the underside of the landing surface.

5. The platform of claim 1, wherein the legs are removable and the landing surface further comprises storage for the legs on the underside.

6. The platform of claim 1, wherein the handle is formed by one or more cutout sections within the landing surface.

7. The platform of claim 1, wherein the landing surface is shaped as one of: a circle, an oval, an octagon, a square and a rectangle.

8. The platform of claim 1, wherein the legs are adjustable in height.

9. The platform of claim 8, wherein the legs are adjustable in height via rotation of a screw thread.

10. The platform of claim 8, wherein the legs are adjustable in height via extension and retraction of a telescoping mechanism.

11. The platform of claim 1, wherein the number of legs is at least four.

12. The platform of claim 1, wherein the legs are secured in a symmetrical pattern.
